(19) United States
(12) Patent Application Publication
(10) Pub. No.: US 2017/0320354 A1
(43) Pub. Date: Nov. 9, 2017

(54) ADJUSTABLE T SQUARE ALIGNMENT DEVICE

(71) Applicant: Steve Brown, London, KY (US)

(72) Inventor: Steve Brown, London, KY (US)

(21) Appl. No.: 15/146,926

(22) Filed: May 5, 2016

(51) Int. Cl. B43L 7/02

(52) U.S. Cl. CPC B43L 7/02

(57) ABSTRACT

An adjustable T square alignment device for providing enhanced flexibility while cutting drywall or other planar objects. The adjustable T square alignment device comprises a blade defining a rigid, elongated structural body having an integral elongated sliding slot, a head defining a rigid structural member having a wide base portion and a narrow sliding portion, and a fastening system operative to both secure the head to the blade, with the sliding portion positioned in the sliding slot, and fix the head at a desired lengthwise position on the blade. In this regard, the head may be selectively repositioned along the length of the blade by sliding it lengthwise but not moved angularly relative to the blade.

### BACKGROUND OF THE INVENTION

### Field of the Invention

This invention relates generally to cutting tools and, more particularly, to an adjustable T square style alignment device for cutting drywall or other planar objects.

### Description of the Prior Art

The design and use of conventional T squares as a drawing or cutting instrument used as a guide for drawing horizontal lines on a drafting table or to measure and cut drywall is well known. Conventional T squares typically include an elongated shaft, often referred to as a “blade,” having a short shaft, often called a “head” (or “stock”) fixed to one end. A problem which still exists, however, is that because the head of conventional T squares is permanently fixed to one end of the blade, it is often difficult to make long continuous lines or cuts without straying from the original straight line. Thus, there remains a need for an adjustable T square alignment device which includes a head that may be selectively positioned in one of a desire position at the time of use. It would be helpful if such an adjustable T square alignment device included a discrete head which was slidably connectable to a discrete blade. It would be additionally desirable for such an adjustable T square alignment device to employ a fastening system which enabled the head to fixed in a desired lengthwise position on the blade without the use of tools.

The Applicant's invention described herein provides for an adjustable T square alignment device adapted to allow a user to selectively reposition the head while using the device. The primary components in Applicant's adjustable T square alignment device are a blade, a head, and a fastening system. When in operation, the adjustable T square alignment device enables more effective alignment over larger linear spaces or for right angles. As a result, many of the limitations imposed by prior art structures are removed.

### SUMMARY OF THE INVENTION

An adjustable T square alignment device for providing enhanced flexibility while cutting drywall or other planar objects. The adjustable T square alignment device comprises a blade defining a rigid, elongated structural body having an integral elongated sliding slot, a head defining a rigid structural member having a wide base portion and a narrow sliding portion, and a fastening system operative to both secure the head to the blade, with the sliding portion positioned in the sliding slot, and fix the head at a desired lengthwise position on the blade. In this regard, the head may be selectively repositioned along the length of the blade by sliding it lengthwise but not moved angularly relative to the blade.

It is an object of this invention to provide an adjustable T square alignment device which includes a head that may be selectively positioned in one of a desire position at the time of use.

It is another object of this invention to provide an adjustable T square alignment device which includes a discrete head which was slidably connectable to a discrete blade.

It is yet another object of this invention to provide an adjustable T square alignment device which employs a fastening system which enabled the head to fixed in a desired lengthwise position on the blade without the use of tools.

These and other objects will be apparent to one of skill in the art.

### BRIEF DESCRIPTION OF THE DRAWINGS

FIG. 1A is a side elevational view of the head member of an adjustable T square alignment device built in accordance with the present invention.

FIG. 1B is a top plan view of the head member of an adjustable T square alignment device built in accordance with the present invention.

FIG. 2A is a top plan view of the blade member of an adjustable T square alignment device built in accordance with the present invention.

FIG. 2B is a side elevational view of the blade member of an adjustable T square alignment device built in accordance with the present invention.

FIG. 3A is a top plan view of an adjustable T square alignment device built in accordance with the present invention.

FIG. 3B is a side elevational view of a cross section of an adjustable T square alignment device built in accordance with the present invention.

### DETAILED DESCRIPTION OF THE INVENTION

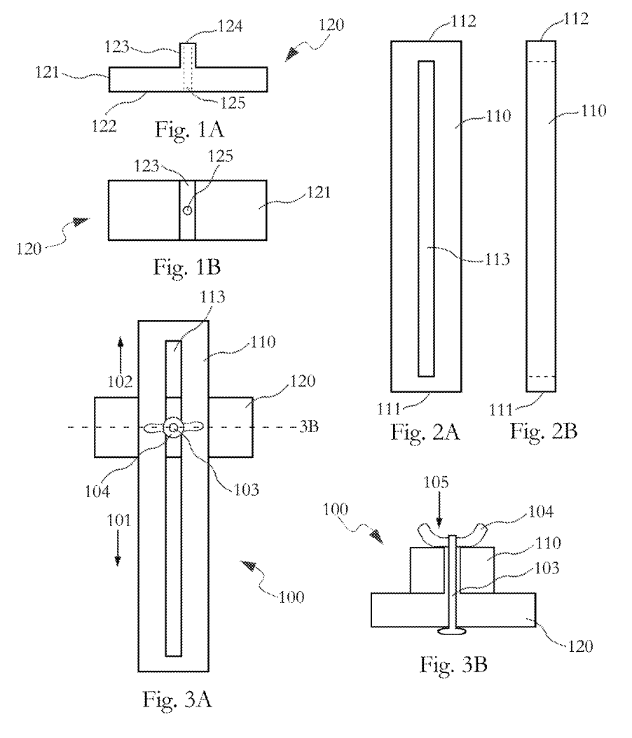

Referring now to the drawings and in particular FIGS. 1A, 1B, 2A, 2B, 3A, and 3B, an adjustable T square alignment device 100 is shown having a blade 110, a head 120, and a fastening system. The blade 110 defines a rigid, elongated structural body having a proximal end bordered by a proximal edge 111, a distal end bordered by a distal edge 112, and a sliding slot 113 which extends from the proximal end to the distal end. In one embodiment, the body of the blade 110 is a cuboid shape and the sliding slot 113 represents a cuboid shaped aperture in the blade 110.

In one embodiment, the blade 110 measures twenty four (24) inches long and is one half (½) inch deep.

The head 120 defines a rigid structural member having a wide base portion 121 with a bottom surface 122 and a narrow sliding portion 123 with a top surface 124. The head 120 additionally includes an attachment hole 125 that passes therethrough from the top surface 124 to the bottom surface 122. In one embodiment, the sliding portion 123 is sized to frictionally fit in the sliding slot 113 such that when the sliding portion 123 is positioned in the sliding slot 113, the head 120 may be slid lengthwise in a proximal direction 101 or a distal direction 102 along the blade 110 but not moved angularly relative to the blade 110.

In one embodiment, the head 120 measures four (4) inches long and totals one (1) inch deep, with each of the base portion 121 and sliding portion 123 measuring one half (½) inches.

The fastening system operates to both secure the head 120 to the blade 110, with the sliding portion 123 positioned in the sliding slot 113 and fix the head 120 at a desired lengthwise position on the blade 110. In one embodiment, the fastening system defines an elongated screw 103 sized to pass completely through the attachment hole 125, as illustrated in FIG. 3B and a wingnut 104 that is attachable to the end of the screw 103. It is contemplated that in such an embodiment, the wingnut 104 may be tightened on the screw 103 sufficiently to exert a force in a fastening direction 105 that holds the head 120 against the blade 110 at a set lengthwise position on the blade 110.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. An adjustable alignment device, comprising:
a blade defining a rigid, elongated structural body having a proximal end bordered by a proximal edge, a distal end bordered by a distal edge, and a sliding slot which extends from the proximal end to the distal end;
a head defining a rigid structural member having a base portion with a bottom surface and a narrow sliding portion with a top surface, wherein said sliding portion is sized to frictionally fit in the sliding slot such that when the sliding portion is positioned in the sliding slot, the head is coupled with the blade and the head is slidable lengthwise in a proximal direction or a distal direction along the blade but not moved angularly relative to the blade; and
a fastening system adapted to secure the head to the blade when with the sliding portion is positioned in the sliding slot thereby fixing the head at a desired lengthwise position on the blade.

2. The adjustable alignment device of claim 1, wherein:
said head includes an attachment hole; and
said fastening system is adapted to engage said attachment hole.

3. The adjustable alignment device of claim 2, wherein said attachment hole extends through the head from the bottom surface to the top surface.

4. The adjustable alignment device of claim 3, wherein said fastening system includes an elongated fastener and a fastener with a threaded hole.

5. The adjustable alignment device of claim 4, wherein said elongated fastener defines a screw and said fastener with a threaded hole defines a wingnut.

6. The adjustable alignment device of claim 1, wherein said sliding slot extends from the proximal end to the distal end without contacting the proximal edge or the distal edge.
